(19) United States
(12) Patent Application Publication
(10) Pub. No.: US 2006/0291689 A1
(43) Pub. Date: Dec. 28, 2006

(54) Surround for speaker

(75) Inventor: Yen-Chen Chan, TAIPEI (TW)

Correspondence Address: YEN-CHEN CHAN, P.O. BOX 108-00403, TAIPEI, TW

(73) Assignee: Ms. Yen-Chen Chan, Taipei Hsien. (TW)

(21) Appl. No.: 11/160,042

(22) Filed: Jun. 7, 2005

(51) Int. Cl. H04R 9/06

(52) U.S. Cl. 381/398

(57) ABSTRACT

An elastically deformable surround for speaker is disclosed to have two elastic surround elements and a cloth lining fixedly mounted in between the elastic surround elements, each elastic surround element having an inner diameter portion for the mounting of a cone, an outer diameter portion for fastening to a basket, and an annular surface portion smoothly arched in transverse direction and extending around the inner diameter portion and connected between the inner diameter portion and the outer diameter portion.

### BACKGROUND OF THE INVENTION

1. Field of the Invention

The present invention relates to a speaker and more particularly, to a surround for speaker, which comprises two elastic surround elements, and a cloth lining bonded in between the elastic surround elements to improve the toughness of the surround.

2. Description of the Related Art

Since the invention, speaker has been intensively used in houses, public places, transportable vehicles, electronic products, and etc., for increasing sound. Nowadays, speaker has become one of our daily requisites. Follow fast development of technology and change of living style, people are critical to the requirement of the sound quality of a speaker. In addition to the requirement of increasing sound, sound quality is an important factor must be taken into account when selecting a speaker.

A speaker includes some parts, i.e., the outer basket, surround and cone, and the inner exciter. Every part has a great concern with the performance of the speaker. FIGS. 5 and 6 show the outer appearance of a surround and a speaker. As illustrated, the speaker comprises a basket A, an exciter B mounted in the center area within the holding space A1 of the basket A, a cone C suspending around the exciter B, and a surround D fastened to the rim of the basket A and connected to the periphery of the cone C to hold the cone C around the exciter B. During working of the exciter B, the cone C is moved up and down to produce sound. The maximum amount of displacement of the cone C is the stroke of the speaker. The surround D is designed to give a support to the cone C. The surround D is made of an elastic material, having a curved surface portion D1 to fit the motion of the cone C.

However, because the surround D has only one curved surface portion D1 extending around the border area, the supporting power of the surround D to the cone C is limited. If the stroke of the speaker surpassed the supporting power provided by the surround D to the cone C, a distortion of sound will occur. In this case, the user cannot enjoy a high quality of sound. If to extend the size of the curved surface portion D1, the supporting power will be relatively reduced, and the stroke of the cone C will be relatively increased, resulting in distortion of sound. Further, changing the size of the curved surface portion D1 of the surround D must relatively change the structure of the basket A and the cone C, thereby increasing the manufacturing cost.

Therefore, it is desirable to provide a surround that eliminates the aforesaid drawbacks.

### SUMMARY OF THE INVENTION

The present invention has been accomplished under the circumstances in view. It is therefore the main object of the present invention to provide a surround that gives a strong support to the cone against displacement of the cone, eliminating the possibility that the stroke of the cone surpasses the supporting power of the surround, and preventing distortion of sound. To achieve this and other objects of the present invention, the surround comprises two elastic surround elements, and a cloth lining fixedly mounted in between the elastic surround elements. Each elastic surround element has an inner diameter portion for the mounting of a cone, an outer diameter portion for fastening to a basket, and an annular surface portion smoothly arched in transverse direction and extending around the inner diameter portion and connected between the inner diameter portion and the outer diameter portion. The cloth lining reinforces the structural strength of the surround, so that the surround does not break during fabrication of the speaker and can bear a comparatively higher stroke during the operation of the speaker.

### BRIEF DESCRIPTION OF THE DRAWINGS

FIG. 1 is an exploded view of the present invention.

FIG. 2 is an elevational view of FIG. 1.

FIG. 3 is a sectional view showing the installation of the surround with the cone in a speaker according to the present invention (I).

FIG. 4 is a sectional view showing the installation of the surround with the cone in a speaker according to the present invention (II).

FIG. 5 is an elevational view of an alternate form of the present invention.

FIG. 6 is an elevational view of a surround and a cone in the surround according to the prior art.

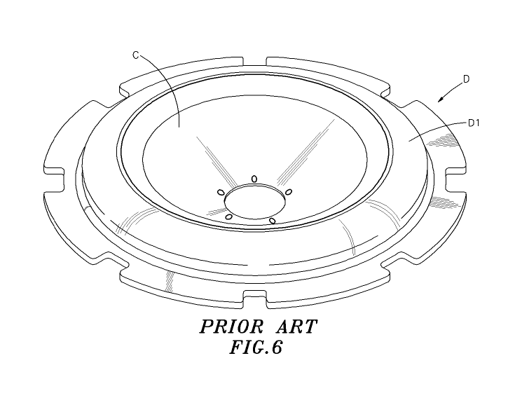

FIG. 7 is a sectional view of a speaker constructed according to the prior art.

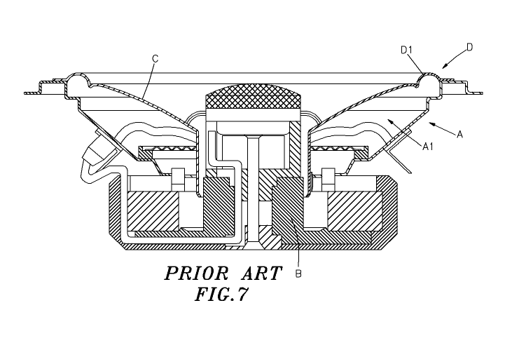

### DETAILED DESCRIPTION OF THE PREFERRED EMBODIMENT

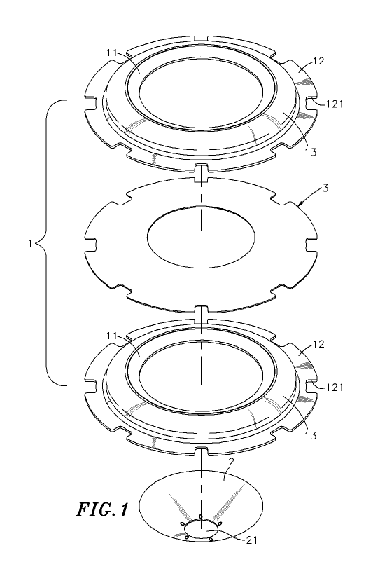

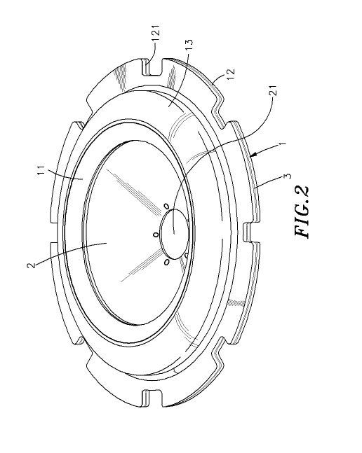

Referring to FIGS. 1 and 2, a surround for speaker in accordance with the present invention is shown comprised of two elastic surround elements 1 and a cloth lining 3 bonded in between the two elastic surround elements 1. The elastic surround elements 1 each have an inner diameter portion 11, an outer diameter portion 12 extending around the inner diameter portion 11, a plurality of locating notches 121 equiangularly spaced around the border of the outer diameter portion 12, and an annular surface portion 13 smoothly arched in transverse direction and connected between the inner diameter portion 11 and the outer diameter portion 12. A cone 2 is fixedly fastened to the inner diameter portions 11 of the elastic surround elements 1 having a center through hole 21. The cloth lining 3 can be fastened to the elastic surround elements 1 by press bonding, heat sealing, or any of a variety of conventional fastening techniques.

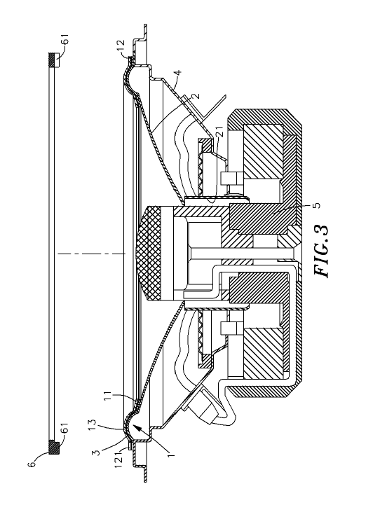

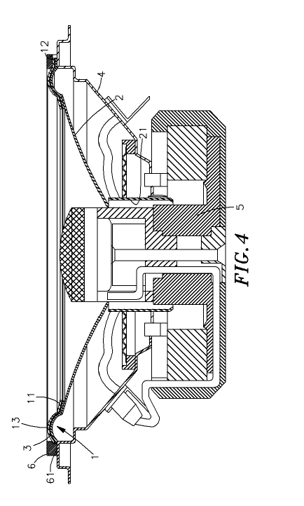

Referring to FIGS. 3 and 4 and FIG. 2 again, during assembly process of the speaker, the surround 1;3 and the cone 2 are put in a basket, referenced by 4 for enabling an exciter, referenced by 5, to pass through the center through hole 21 of the cone 2 and the outer diameter portions 12 of the elastic surround elements 1 to be attached to the surface of the basket 4, and then a locating ring 6 is attached to the outer diameter portions 12 of the elastic surround elements 1 to force bottom flanges 61 of the locating ring 6 into engagement with the locating notches 121, thereby holding down the surround 1;3 in the basket 4.

During working of the exciter 5, the cone 2 is continuously moved up and down to produce sound, and the maximum amount of displacement of the cone 2 is the stroke of the speaker. At this time, the elastically deformable material property of the elastic surround elements 1 give a sufficient support to the cone 2, eliminating the possibility that the stroke of the cone 2 surpasses the supporting power of the surround and therefore preventing distortion.

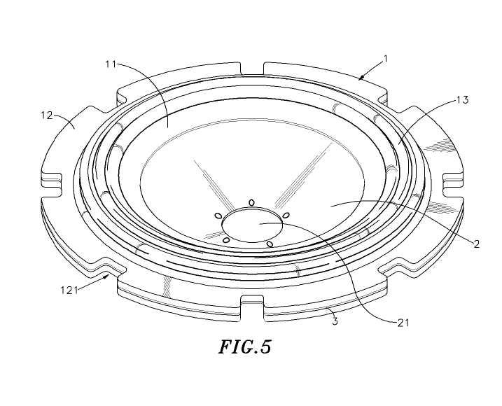

FIG. 5 shows an alternate form of the present invention. According to this embodiment, each elastic surround element 1 has a plurality of annular surface portions 13 smoothly arched in transverse direction and arranged one within another around the inner diameter portion 11 and connected between the inner diameter portion 11 and the outer diameter portion 12. The number of the annular surface portions 13 can be changed subject to the requirements of the speaker (for example, width of sound range, range of output power, etc.) so that the speaker can provide a comparatively better sound quality. When changing the number of the annular surface portions 13, the curvature and arrangement of the annular surface portions 13 can be relatively changed, maintaining the same width.

Further, the elastic surround elements 1 can be made of sponge. The cloth lining 3 can be made of spandex or non-elastic fabric.

As indicated above, the present invention provides a surround for speaker, which is comprised of two elastic surround elements and a cloth lining bonded in between the two elastic surround elements. The cloth lining reinforces the structural strength of the surround and enhances the toughness of the surround, allowing the surround to support a great stroke and a high sound volume so that the speaker can produce loud and clear sound. Further, each elastic surround element has multiple annular surface portions connected between the inner diameter portion and outer diameter portion and respectively extending one within another around the inner diameter portion to provide a strong support to the cone against displacement of the cone, eliminating the possibility that the stroke of the cone surpasses the supporting power of the surround, and therefore the surround prevents distortion of sound. Further, the number of the annular surface portions of the elastic surround elements can be changed subject to the requirements of the speaker. When changing the number of the annular surface portions of the elastic surround elements, the curvature and arrangement of the annular surface portions can be relatively changed, maintaining the same width.

A prototype of surround for speaker has been constructed with the features of FIGS. 1˜5. The surround for speaker functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A surround comprising two elastic surround elements, a cloth lining fixedly mounted in between said elastic surround elements, and fastening means to affix said cloth lining to said elastic surround elements, said elastic surround elements each having an inner diameter portion for the mounting of a cone, an outer diameter portion for fastening to a basket, and an annular surface portion smoothly arched in transverse direction and extending around said inner diameter portion and connected between said inner diameter portion and said outer diameter portion.

2. The surround as claimed in claim 1, wherein said fastening means is press bonding.

3. The surround as claimed in claim 1, wherein said fastening means is heat sealing.

4. The surround as claimed in claim 1, wherein said elastic surround elements each have a plurality of locating notches equiangularly spaced around the border of the respective outer diameter portion.

5. The surround as claimed in claim 1, wherein said elastic surround elements are made of sponge.

6. The surround as claimed in claim 1, wherein said cloth lining is made of an elastic cloth.

7. The surround as claimed in claim 1, wherein said cloth lining is made of a non-elastic cloth.

8. The surround as claimed in claim 1, wherein said cloth lining is covered on two sides of said elastic surround elements.

9. A surround comprising two elastic surround elements, a cloth lining fixedly mounted in between said elastic surround elements, and fastening means to affix said cloth lining to said elastic surround elements, said elastic surround elements each having an inner diameter portion for the mounting of a cone, an outer diameter portion for fastening to a basket, and a plurality of annular surface portions respectively smoothly arched in transverse direction and arranged one within another around said inner diameter portion and connected between said inner diameter portion and said outer diameter portion.

10. The surround as claimed in claim 9, wherein said fastening means is press bonding.

11. The surround as claimed in claim 9, wherein said fastening means is heat sealing.

12. The surround as claimed in claim 9, wherein said elastic surround elements each have a plurality of locating notches equiangularly spaced around the border of the respective outer diameter portion.

13. The surround as claimed in claim 9, wherein said elastic surround elements are made of sponge.

14. The surround as claimed in claim 9, wherein said cloth lining is made of an elastic cloth.

15. The surround as claimed in claim 9, wherein said cloth lining is made of a non-elastic cloth.

16. The surround as claimed in claim 9, wherein said cloth lining is covered on two sides of said elastic surround elements.
